(19) United States
(12) Patent Application Publication
(10) Pub. No.: US 2014/0075282 A1
(43) Pub. Date: Mar. 13, 2014

(54) METHOD AND APPARATUS FOR COMPOSING A REPRESENTATIVE DESCRIPTION FOR A CLUSTER OF DIGITAL DOCUMENTS

(71) Applicant: REDIFF.COM INDIA LIMITED, Mumbai (IN)

(72) Inventors: Vishal Shah, Mumbai (IN); Kalpana Banerjee, Chennai (IN); Surabhi Khandavalli, Navi Mumbai (IN); Gaurav Ruhela, New Delhi (IN)

(21) Appl. No.: 13/926,937

(22) Filed: Jun. 25, 2013

(30) Foreign Application Priority Data
Jun. 26, 2012 (IN) 1833/MUM/2012

(51) Int. Cl. G06F 17/24

(52) U.S. Cl. CPC G06F 17/241
USPC 715/231

(57) ABSTRACT

Embodiments of the present invention provides a method and apparatus for composing a representative description. The method includes selecting a first query candidate (QC) from multiple query candidates (QCs), identifying a second QC from the multiple QCs, analysing overlap in content of the second QC and in content of the first QC. Each of the multiple QCs has a score. The first QC has highest score. Each of the multiple QCs is extracted from a cluster of one or more digital documents.

### CROSS REFERENCE TO RELATED APPLICATIONS

This application claims the benefit of corresponding Indian Patent Application titled “Method And Apparatus For Composing A Representative Description For A Cluster Of Digital Documents” filed on Jun. 18, 2013, which is a non provisional application of the Indian Provisional Patent Application titled “Method And Apparatus For Presenting Relevant Articles And Representative Information Thereof” filed on Jun. 26, 2012, both having the Application No. 1833/MUM/2012, which are herein incorporated by reference in their entirety.

### BACKGROUND

1. Field of the Invention

Embodiments of the present invention generally relate to showcasing information and more particularly, to method and apparatus for composing a representative description for a cluster of digital documents.

2. Description of the Related Art

Managing information load from multiple sources and presenting the information in an intelligible form is a routine editing task performed by web portals such as news portals. Along with being intelligible, the information presented is required to have comprehensive coverage, appropriate categorization and temporal sensitivity. Various clustering techniques are used to categorize the huge amount and diverse information collected and various techniques are used to showcase such information. While some techniques of showcasing information deal with providing a summary of content using various natural language processing techniques or manual journalistic skill. Other techniques of showcasing information deal with providing a representative description of the contents, such as a title or topic. Other than differences in method involved in providing summary and representative descriptions, one important difference between showcasing information by summarizing and showcasing information by representative description is content of summaries and representative descriptions. Summaries generally includes significant details of the information content in condensed form and representative description generally includes keywords related to and indicating significant details of the information content.

Further, categorized information data is processed further for showcasing the information by providing appropriate representative description, such as a topic and an image to a consumer. Such representative description needs to be succinct while providing relevant and wholesome idea of what the information deals with. Techniques used for generating representative description generally involve automatic selection of predetermined parts of the information. For example, a headline of a news article may be used to represent an entire cluster of news articles relating to an event. Such automated selection has various drawbacks including absence of check on quality, content and effectiveness of the chosen representative data and dependency on external source for representative data. Content of the headline automatically selected for representing the entire cluster may not be effective in conveying details contained in content of the news articles of the cluster. Further, the content of the headline may not even be a true representation of information contained in the news articles of the cluster.

Some conventional techniques used for generating representative data consume considerable editorial skill and manual effort to extract and select portions of information that is to be used to showcase the categorized data. However, such manual selection, though may provide appropriate representative data, suffers the disadvantage of being time consuming. Time consumption becomes a huge limitation if the information being presented needs to be temporally sensitive. Repeating the process of generating representative data with each update of information becomes a very cumbersome task.

Therefore, there is a need for method and apparatus for composing a representative description for a cluster of digital documents.

### SUMMARY OF THE INVENTION

Embodiments of the present invention provides a method and apparatus for composing a representative description. The method includes selecting a first query candidate (QC) from multiple query candidates (QCs), identifying a second QC from the multiple QCs, analyzing overlap in content of the second QC and in content of the first QC. Each of the multiple QCs has a score. The first QC has highest score. Each of the multiple QCs is extracted from a cluster of one or more digital documents.

### BRIEF DESCRIPTION OF THE DRAWINGS

FIG. 1 depicts a schematic diagram of a system for composing a representative description according to an embodiment of the present invention;

FIG. 2 depicts a flow diagram of a method of generating one or more query candidate corpuses according to an embodiment of the present invention;

FIG. 3 depicts a schematic diagram of a description composer of FIG. 1 according to an embodiment of the present invention;

FIG. 4 depicts a flow diagram of a method for composing a representative description according to an embodiment of the present invention; and

FIG. 5 depicts an exemplary screenshot of a user interface showcasing information by a representative description composed for each cluster of digital documents, according to an embodiment of the present invention.

While the method and apparatus is described herein by way of example for several embodiments and illustrative drawings, those skilled in the art will recognize that the method and apparatus for composing a representative description are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for composing a representative description as defined by the embodiments. Any headings used herein are for organizational purposes only and are not meant to limit the scope of the description or the embodiments. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention comprise a method and apparatus for composing a representative description for a cluster of digital documents. The representative description may be used to showcase information on user interface of a web portal accessing digital documents available on the internet or a personal digital assistant (PDA) such as tablets, mobile phones etc. with digital documents stored on the PDA. The representative description is composed using one or more query candidates (QCs). The QCs are extracted from one or more digital documents of the cluster. According to an embodiment, the QCs are sequences of words similar to search queries received on a search engine. Extraction of QCs is described in detail below. The technique selects a first query candidate (QC) with highest score to compose the representative description. Further, the technique combines the first QC with a second QC, if the second QC is sufficiently different from the first QC so as to substantially enhance information being conveyed by the representative description. Further, the technique considers the second QC for combining if the score of the second QC is above a predefined threshold to ensure that only significant content of the digital documents is added to the representative description. Those skilled in the art will appreciate that using QCs to compose the representative description enhances information navigation experience of the user. The representative description showcases information contained in a cluster of digital documents and QCs extracted from these digital documents are used to compose the descriptive information. When such representative description is used as query on an automated retrieval system for navigating information, the search results obtained are likely to be extremely relevant,

Unless indicated otherwise, the term “article” or derivatives thereof shall be understood to mean document(s) having at least some text content, such as those generally known in the art. In the following detailed description, numerous specific details are set forth to provide a thorough understanding of the disclosed subject matter. However, it will be understood by those skilled in the art that disclosed subject matter may be practiced without these specific details. In other instances, methods, apparatuses or systems that would be known by one of ordinary skill have not been described in detail so as not to obscure disclosed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

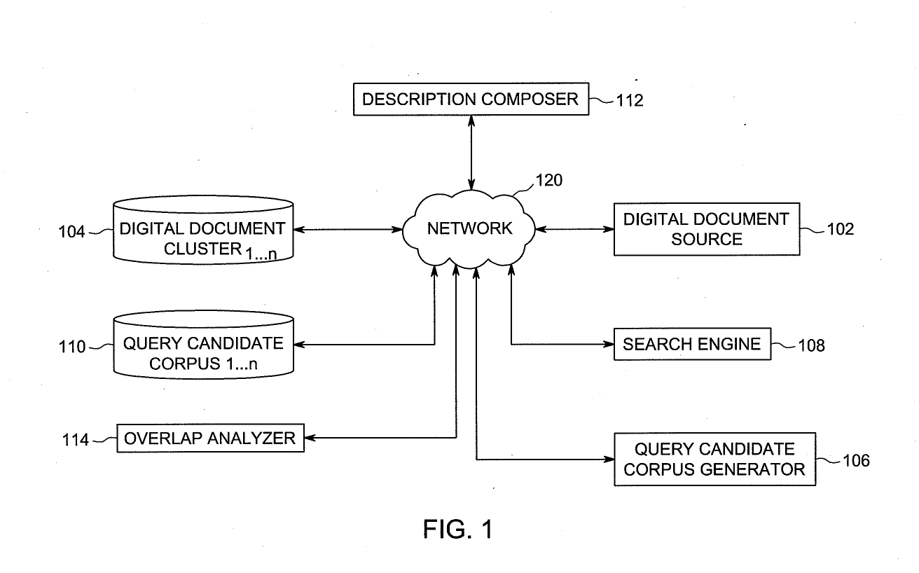

Embodiments of the present invention provide method and apparatus for composing a representative description. FIG. 1 depicts a block diagram of a system 100 for composing a representative description, according to one or more embodiments of the invention. The system 100 comprises one or more digital document (DD) sources 102, (multiple DD sources illustrated in FIG. 1 by numerals 102₁ . . . 102ₙ), one or more digital document clusters 104, (multiple DD cluster illustrated in FIG. 1 by numerals 104₁ . . . 104ₙ), a query candidate (QC) corpus generator 106, a search engine 108, one or more QC corpuses 110 (multiple QC corpus illustrated in FIG. 1 by numerals 110₁ . . . 110ₙ), a description composer 112, an overlap analyzer 114 and a network 120. The description composer 112 uses the overlap analyzer 114 to compose the representative description using one or more query candidates in the one or more QC corpuses 110 generated from corresponding one or more DD clusters 104. As the query candidates of the one or more QC corpuses 110 are generated from the corresponding one or more DD clusters 104, content of the representative description composed using such one or more query candidates depicts content of the one or more DD of the one or more DD clusters 104. Implementation of the description composer 112 and the overlap analyzer 114 is described in detail below. The one or more DD clusters 104 as referred to herein may include one or more digital documents having a commonality. For example if the one or more digital documents are news articles, the one or more clusters 104 includes one or more news articles about one story from one or more DD sources 102.

In some embodiments, the network 120 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface may support communication via wired or wireless general data networks, such as any suitable type of Ethernet network, for example; via telecommunications/telephony networks such as analog voice networks or digital fiber communications networks; via storage area networks, such as Fiber Channel SANs, or via any other suitable type of network and/or protocol.

The one or more DD sources 102, the one or more DD clusters 104, the QC corpus generator 106, the search engine 108, the one or more QC corpuses 110 and the description composer 112 are computing devices configured for storing, exchanging digital content over the network 120, processing and displaying such content and providing a user interface. The one or more DD sources 102 is a computing device for example, used by publishers to publish news articles, shopping products and catalogues, books, deals, job listings, Wikipedia articles and the like. The multiple DDs obtained from the one or more DD sources 102 are clustered using techniques generally known in the art to obtain one or more DD clusters 104. The one or more DD clusters 104 includes computing devices storing DDs, metadata related to the DDs and the like. According to an embodiment, the one or more DD clusters 104 includes one or more DDs related to one event/concept or subject. The clustering technique used may be configured to obtain clusters according to desired tightness of relatedness between the one or more DDs in the cluster. The DDs may be news articles, editorials, commentaries by experts in the field among others.

The QC corpus generator 106 may generate query candidates (QCs) using various techniques described in detail below. The QC corpus generator 106 generates one or more QCs, that are stored in one or more QC corpuses 110 for each of the one or more DD clusters 104. The QC corpus generator 106 may use various techniques for generating the one or more QCs described below in detail.

Those skilled in the art will appreciate that the various functionalities of the one or more DD sources 102, the one or more DD clusters 104, the QC corpus generator 106, the search engine 108, the one or more QC corpuses 110, the description composer 112, the overlap analyzer 114 can be configured differently, for example, using the devices of the system 100 for different functionality, or using other devices communicably coupled to the network 120 to achieve these functionalities, and similar such configurations, all of which are included within the scope and spirit of the invention.

According to several embodiments, the system 100 includes a DD sourcing module, for example, a Crawler (not shown). This component is responsible for crawling multiple sites at regular intervals using their RSS feeds or hub pages. Each hub page may be associated with a news category (from a pre-defined set of categories like Business, Politics, Technology etc.), Location (Country/State/City/Locality), and other metadata as available. According to some embodiments, the system 100 includes a component extracting module (not shown), for example extracting text and image, and other components from the article. In some embodiments, the component extracting module downloads the actual URL of the DD to get the complete content of the DD. Although the entire contents of the DD may not be ever displayed to a user, the DD is used for searching, and also for clustering/analysis. The component extracting module specifically analyzes the DOM structure of the HTML of the DD, and extracts only the actual text of the DD. In the process, the component extracting module strips out irrelevant components of the page such as advertisements, navigational links, related stories, user comments, and the like.

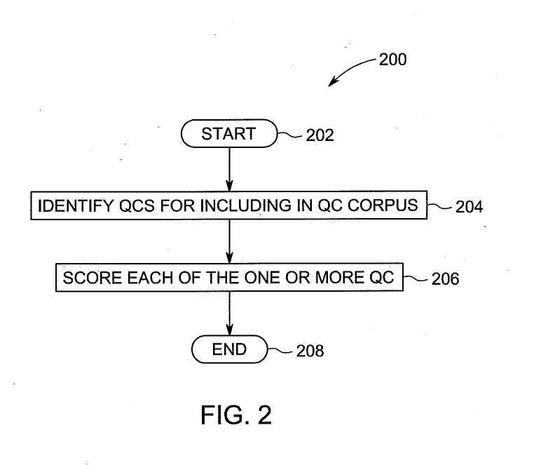

FIG. 2 depicts a flow diagram of a method 200 of generating one or more query candidate corpuses, for example, the one or more query candidate corpuses 110 of FIG. 1 according to an embodiment of the present invention. The method 200 begins at step 202 and proceeds to step 204. At the step 204, the method 400 identifies the one or more QCs to be included in the one or more QC corpuses. According to an embodiment, the QC corpus generator 106 may identify the one more QCs by a QC generating method described in Indian patent application number 1820/MUM/2012, titled ‘Method and apparatus for query candidate extraction’ and Indian patent application number 1833/MUM/2012 titled ‘Method and apparatus for presenting relevant articles and representative information thereof’ incorporated herein by reference in their entirety described briefly herein. The QC generating method includes extracting sequence of words (such as a phrase, clause and sentence) from one or more digital documents of the one or more DD clusters, for example, the one or more DD clusters 104, tagging (using for example, parts of speech tagger) the sequence of words to obtain a sequence of tags, comparing the sequence of tags with one or more reference sequences and selecting the sequence of words as QC if the sequence of tags matches with the one or more reference sequences. The one or more reference sequences are obtained by tagging multiple search queries received by, for example the search engine 108. According to one embodiment, the QC corpus generator 106 may extract multiple n-grams (unigrams, bigrams, trigram etc.) from each of the one or more DDs of each of the one or more DD clusters and match each of the multiple n-grams to one or more predetermined QCs extracted by methods generally known in the art. If the extracted n-gram matches one or more predetermined QCs, such n-gram is selected as a QC and included in the QC corpus. According to one embodiment, the one or more predetermined QCs may be extracted by the QC generating method described in Indian patent application number 1820/MUM/2012, titled ‘Method and apparatus for query candidate extraction’ incorporated herein by reference in its entirety. DDs used to extract such one or more predetermined QCs may or may not be included in the cluster from which the multiple n-grams are extracted. According to yet another embodiment, the QC corpus generator 106 may identify QCs using generally known in the art techniques such as named entity taggers.

At step 206, the method 200 assigns a score to each of the one or more QCs in each of the one or more QC corpuses 110. Those skilled in the art will appreciate that the scores may be used for ranking the QCs. For example, a QC with highest score among multiple QCs assigned the score may be considered to have the highest rank and similarly other QCs having score lower than the highest score may form an ordered list in descending order of score and rank. The score is assigned according to one or more features of the QC. The one or more features comprise at least one of term frequency (TF), document frequency, credibility (for example, publisher credibility, impact factor of scientific journals, website credibility etc.) of the DDs from which the QC is extracted, countries of origin of the DDs from which the QC is extracted, category of subject matter of DD from which the QC is extracted, recency of the DD from which the QC is extracted, number of DD from which the QC is extracted originating from preferred country, number of DD from which the QC is extracted having global relevance. Further, each of these features may have a weightage for score calculation. Such scoring provides a means for identifying preferred QCs.

TF is the number of times the QC appears in titles or descriptions of the one or more DDs in the cluster. DF is the number of the one or more DDs in the cluster containing one or more occurrences of the QC in either the title or description. Category of the DD is an feature to indicate whether the article relates to politics, sports, entertainment, weather or several other categories as will occur to those skilled in the art. Included feature of recency of the DD provides for distinguishing the more recent DD. Similarly, included feature of country of origin enables a comparative analysis between preferred country and global articles and understand the relevance of a QC with respect to preferred country and the world. Such comparison is a part of the identifying and/or introducing a regional bias. Further such score may be assigned to each of the multiple QCs based on value computed for each of the one or more features with respect to one or more DDs of the cluster. According to one embodiment, if the QCs are identified by matching n-grams to one or more predetermined QCs extracted by the QC generating method described in Indian patent application number 1820/MUM/2012, titled ‘Method and apparatus for query candidate extraction’, the one or more predetermined QCs have an assigned score computed based value of on one or more features with respect to DDs data used to extract such one or more predetermined QCs. Again, as described above, DDs used to extract and score such one or more predetermined QCs may or may not be included in the cluster from which the multiple n-grams are extracted. The method proceeds to step 208 and ends.

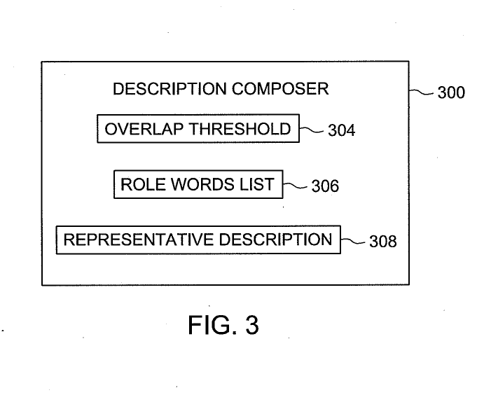

FIG. 3 depicts a schematic diagram of a description composer 300 of FIG. 1 according to an embodiment. In some embodiments, the description composer 200 is a type of computing device (e.g., a laptop, a desktop, a Personal Digital Assistant (PDA) and/or the like) known to one of ordinary skill in the art. The description composer 300 includes, an overlap level 304, an role words list 306 and a representative description 308. According to some embodiments, various modules described above can interoperate, use the other module's output or initiate the operation of the other module.

The description composer 300 uses the QCs stored in the QC corpus 110 to compose the representative description 308 and as described above each QC of the multiple QCs stored in the QC corpus is assigned a score. As such the description composer 300 is configured to compose the representative description to bring forth the most significant sequence of words (or phrase) and have high information density. Those skilled in the art will appreciate that the most significant phrase is likely to have the highest score. The description composer 300 selects a first QC having highest score from the multiple QCs. To enhance information density of the representative description 308, the description composer 308 identifies a second QC having a score lesser than the highest. Though shown here as an independent module, the overlap analyzer 114 may be included in the description composer 300, according to some embodiments. The overlap analyzer 114 analyses overlap in content of the first QC and the second QC. If the overlap is below the overlap level 304, the description composer 300 composes the representative description 308 by appending the second QC to the first QC. Alternatively, if the overlap is above the overlap level 304, the description composer 300 composes the representative description 308 as the first QC.

According to an embodiment, to maintain significancy of the representative description 308, the description composer 300 identifies a second QC having score above a predefined threshold score. Those skilled in the art will appreciate that QCs having a very low score or a score below the predefined threshold score are unlikely to provide true representation of subject matter contained in the one or more DDs of the cluster. Similarly, information density of the representative description 308 is maintained by using an optimally predefined level 304 of overlap. For example, consider the first QC ‘Chief Minister Siddaramaiah’ and the second QC ‘Siddaramaiah’. All words of the second QC are already present in the first QC, giving an overlap of 100% between the first QC and the second QC. Accordingly the second QC is not appended to the first QC to compose the representative description. Another second QC from multiple QCs having score lesser that the first QC and above the predefined threshold score is identified. Consider for example, the second QC is ‘Oath Ceremony’. Overlap between the first QC and the second QC is 0% (overlap is below predefined level. Accordingly, the second QC is appended to the first QC. Considering another example, where the first QC is ‘Oath Ceremony’ and the second QC is ‘Swearing in Ceremony’. In this case, the overlap between the first QC and the second is 50%, and if the predefined level of overlap is, for example, 30%, the second QC is not appended to the first QC. Considering yet another example, where the first QC is ‘Oath Ceremony’ and the second QC is ‘Siddaramaiah’. Since the overlap between the first QC and the second QC is 0% (below the predefined overlap level of, for example 30%), the second QC is appended to the first QC to compose the representative description as ‘Oath Ceremony Siddaramaiah’. Further, when a word at end of the first QC and at beginning of the second QC is same, the description composer identifies that the word at end of the first QC and at beginning of the second QC is same and the second QC is modified by trimming away the word at the beginning. Such modified second QC is appended to the first QC. For example, if the first QC is ‘Railway Budget’ and the second QC is ‘Budget 2012’, the second QC ‘Budget 2012 is modified by trimming away the word at the beginning ‘Budget’. Such modified second QC ‘2012’ is appended to the first QC and the representative description 308 is composed as ‘Railway Budget 2012’. Furthermore, those skilled in the art will appreciate that while appending the first QC with the second QC, the content overlapping between the first QC and the second QC is not concatenated to prevent redundancy of content in representative description 308. For example, if the first QC is ‘inflation 15%’ and the second QC is ‘rise of 15%’, the representative description 308 is composed as ‘inflation rise of 15%’ and the overlapping content in the first QC and the second QC, for example, ‘15%’ of the second QC is not appended to the first QC.

According to several embodiments, the representative description 308 is refined using several techniques to further enhance the information density. Techniques used for refining the representative description 308 include stripping predefined role words and replacing at least part of the sequence of words in the representative description 308 with an acronym. For example, if the representative description 308 comprises a sequence of words ‘Bhartiya Janata Party’, the description composer 200 may replace this sequence with the acronym ‘BJP’. The description composer may detect the sequence of words replaceable with an acronym using a predefined list of acronyms. Alternatively, the description composer 300 may detect the sequence of words replaceable with acronym by comparing with one or more QCs in the QC corpus. One or more QCs in the QC corpus may comprise an acronym for a sequence of words in the representative description 308. For example, if part sequence of words of the representative description 308 is ‘Bhartiya Janata Party’ and one or more QCs from the QC corpus comprises BJP, the description composer 300 replaces the sequence ‘Bhartiya Janata Party’ with BJP.

The role words may for example be common nouns describing a proper noun in the QC. These role words may be predefined and stored as the role words list 306. The description composer 300 may detect the presence of role words by comparing the role words list 306 to the words contained in the representative description 308. Alternatively, the description composer 300 may detect the presence of role words in the representative description 308 by comparing with one or more QCs in the QC corpus and subsequently confirming using the role words list 306. Specifically, if the representative description 308 query candidate begins with one or more role words, and the QC corpus has another QC without the role words, the role words are stripped away from the representative description 308. For example, if the representative description 308 in consideration is ‘Prime Minister Manmohan Singh’, and at least one QC in the QC corpus is ‘Manmohan Singh’ the description composer strips away ‘Prime Minister’ from the representative description 308. The role words list may include role keywords such as Prime minister, President, Cricketer, Actor and the like.

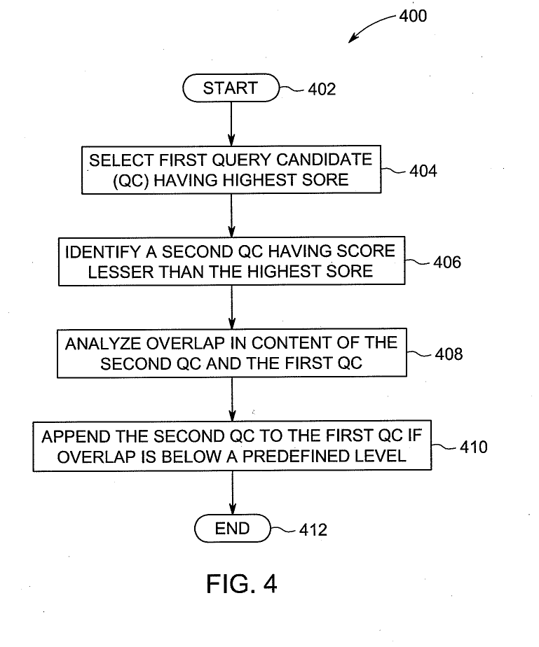

FIG. 4 depicts a flow diagram of a method 400 for composing a representative description, according to an embodiment. The description composer 300 of FIG. 3 and the description composer 112 of FIG. 1 is for example, implemented according to the method 400 described herein. The method 400 begins at step 402 and proceeds to step 404. At the step 404, the method 400 selects the first QC having highest score from the plurality of QCs. At step 406, the method 400 identifies a second QC having score lesser than the highest score. At step 408, the method 408 analyzes overlap in content of the first QC and the second QC. At step 410 the method 400 appends the second QC to the first QC, if overlap between the contents of the first QC and the second QC are below a predefined level as described in detail above. The method 400 ends at step 412.

According to several embodiments the description composer 300 iterates through the multiple QCs in the QC corpus for identification of the second QC in descending order of score. If overlap between contents of the first QC and the QC is above the predefined overlap level, the description composer skips to the next QC in the QC corpus. When the description composer 300 identifies the second QC having overlap in content with the first QC below the predefined overlap level, the iteration is stopped. Also, if during iteration, the score of the next QC is lesser than the threshold score, the iteration is stopped. The description composer 300 composes the representative description having at least one QC, the first QC. Alternatively, the representative description is composed by concatenating two QCs. For example, if the first QC comprises ‘Railway Budget 2012’ and the second QC comprises ‘Dinesh Trivedi’, the two QCs are concatenated to compose the representative description ‘Railway Budget 2012 Dinesh Trivedi’.

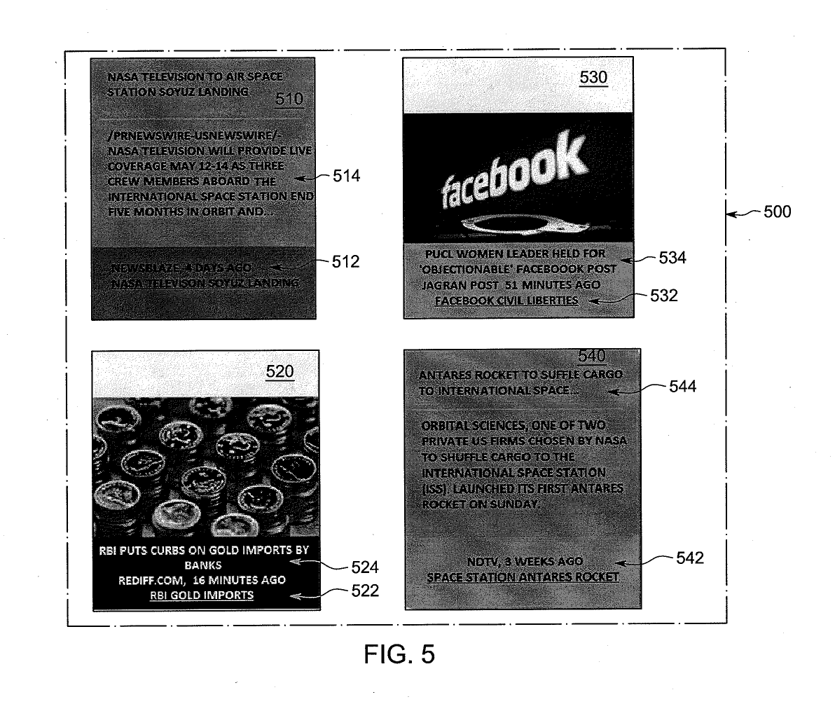

FIG. 5 depicts an exemplary screenshot of a user interface (UI) 500 showcasing information by rendering the representative description composed for each cluster of digital documents, according to an embodiment of the present invention. According to embodiment illustrated in the Figure, the UI 500 comprises four clusters of one or more digital documents 510, 520, 530 and 540. Each of the clusters 510, 520, 530 and 540 comprises one or more digital documents having information 514, 524, 534 and 544 respectively. Only part of the information of one of the digital documents of each cluster is visible due to constraint of space in the UI 500. However, those skilled in the art will appreciate that each of these clusters 510, 520, 530 and 540 may include multiple such digital documents with more information and content. Representative description 512, 522, 532, and 542 for each of the clusters 510, 520, 530 and 540 respectively is composed using one or more QCs according to the technique described above. Each of the representative description 512, 522, 532, and 542 provides important details about digital documents of the respective cluster. Further, those skilled in the art will appreciate that each representative description 512, 522, 532, and 542 comprises significant keywords, which when used to search data comprising digital documents is likely to fetch meaningful results.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Python, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements. FIG. 2 may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of the invention. Finally, structures and functionality presented as discrete components in the example configurations may be implemented as a combined structure or component. These and other variations, modifications, additions, and improvements may fall within the scope of embodiments as defined.

The foregoing is directed to embodiments of the present invention, other and further embodiments of the invention may be devised without departing from the basic scope thereof.

What is claimed is:

1. An apparatus for composing a representative description, the apparatus comprising:
a description composer for
selecting a first query candidate (QC) from a plurality of query candidates (QCs), each of the plurality of QCs having a score, the first QC having highest score;
identifying a second QC from the plurality of QCs; and
an overlap analyser for analysing overlap in content of the second QC and in content of the first QC,
wherein each of the plurality of QCs is extracted from at least one digital document of a cluster.

2. The apparatus of claim 1, wherein the second QC has a score above a predefined threshold score.

3. The apparatus of claim 1, wherein the description composer identifies the second QC from the plurality of QCs according to descending order of the score.

4. The apparatus of claim 1, wherein the description composer appends the second QC to the first QC, other than content overlapping between the first QC and the second query QC to the first QC, when overlap in content of the second QC and in content of the first QC is below a predefined level.

5. The apparatus of claim 1, further renders the representative description on a user interface to depict content of the at least one digital document of the cluster.

6. The apparatus of claim 1, wherein the score is based on at least feature of each of the plurality of QCs, and wherein the at least one feature represents at least one of number of the at least one digital document containing each of the plurality of QCs, number of times each of the plurality of QCs occurs in the at least one digital document, location of each of the plurality of QCs in the at least one digital document, credibility of the at least one digital document containing each of the plurality of QCs, recency of the at least one digital document containing the each of the plurality of QCs, category of content of the at least one digital document containing each of the plurality of QCs, length of each of the plurality of QCs, or originating geography of the at least one digital document containing each of the plurality of QCs.

7. The apparatus of claim 1, wherein the description composer replaces at least part sequence of words of the first QC with an acronym.

8. The apparatus of claim 1, wherein the description composer removes at least one predefined role word from the first QC, the at least one role word comprising a common noun for a proper noun in the first QC.

9. The apparatus of claim 1, wherein the description composer appends the second QC to the first QC other than a word at the beginning of the second QC when a word at end of the first QC and the at beginning of the second QC is same.

10. A method for composing a representative description, the method comprising:
selecting a first query candidate (QC) from a plurality of query candidates (QCs) having a score, the first QC having highest score;
identifying a second QC from the plurality of QCs; and
analysing overlap, using an overlap analyser, in content of the second QC and in content of the first QC, the second QC having a score lesser than the highest score, wherein each of the plurality of QCs is extracted from at least one digital document of a cluster and the score is based on at least one feature of each of the plurality of QCs.

11. The method of claim 10, wherein overlap in content of the second QC and in content of the first QC is below a predefined level.

12. The method of claim 11, further comprising appending the second QC to the first QC, other than content overlapping between the first QC and the second query QC to the first QC, using the description composer.

13. The method of claim 10, wherein the second QC is identified from the plurality of QCs according to descending order of the score.

14. The method of claim 10, wherein the second QC is appended to the first QC, other than content overlapping between the first QC and the second query QC to the first QC, when overlap in content of the second QC and in content of the first QC is below a predefined level.

15. The method of claim 10, further comprising rendering representative description on a user interface to depict content of the at least one digital document of the cluster.

16. The method of claim 10, wherein the score is based on at least feature of each of the plurality of QCs, and wherein the at least one feature represents at least one of number of the at least one digital document containing each of the plurality of QCs, number of times each of the plurality of QCs occurs in the at least one digital document, location of each of the plurality of QCs in the at least one digital document, credibility of the at least one digital document containing each of the plurality of QCs, recency of the at least one digital document containing the each of the plurality of QCs, category of content of the at least one digital document containing each of the plurality of QCs, length of each of the plurality of QCs, or originating geography of the at least one digital document containing each of the plurality of QCs.

17. The method of claim 10 further comprising replacing at least part sequence of words of the first QC with an acronym.

18. The method of claim 10 further comprising removing at least one predefined role word from the first QC, the at least one role word comprising a common noun for a proper noun in the first QC.

19. The method of claim 10 further comprising appending the second QC to the first QC other than a word at the beginning of the second QC when a word at end of the first QC and the at beginning of the second QC is same.

20. A non-transient computer readable storage medium for storing computer instructions that, when executed by at least one processor cause the at least one processor to perform a method for composing a representative description, the method comprising:
selecting a first query candidate (QC) from a plurality of query candidates (QCs) having a score, the first QC having highest score;
identifying a second QC from the plurality of QCs; and
analysing overlap, using an overlap analyser, in content of the second QC and in content of the first QC, the second QC having a score lesser than the highest score, wherein each of the plurality of QCs is extracted from at least one digital document of a cluster and the score is based on at least one feature of each of the plurality of QCs.
